(19) United States
(12) Patent Application Publication
(10) Pub. No.: US 2011/0146113 A1
(43) Pub. Date: Jun. 23, 2011

(54) FISHING DREDGE

(76) Inventor: Richard Gidney, Dumfries and Galloway (GB)

(21) Appl. No.: 13/056,778

(22) PCT Filed: Jul. 31, 2009
(86) PCT No.: PCT/GB09/01866

§ 371 Date: Mar. 8, 2011

(30) Foreign Application Priority Data
Aug. 1, 2008 (GB) 0814058.4
Jan. 26, 2009 (GB) 0901243.6
Jun. 3, 2009 (GB) 0909612.4

(51) Int. Cl. A01K 80/00

(52) U.S. Cl. 37/316

(57) ABSTRACT

A fishing dredge and in particular to a belly (62) for a fishing dredge which comprises a sea bed engaging portion (63) and an upper portion (65). The sea bed engaging portion has a plurality of rotatably mounted rollers (47) and connectors (51) which together form a mesh such that at least one of the rollers forms part of the mesh. The belly (62) can roll across the sea bed thereby reducing the damage to the sea bed caused by dragging existing dredging apparatus across the sea bed.

### INTRODUCTION

The present invention relates to a fishing dredge and in particular to a belly for a fishing dredge.

### BACKGROUND TO THE INVENTION

Dredging is used for harvesting bivalve molluscs such as oysters, clams and scallops. A dredge is a metal framed basket with a bottom of connected iron rings or wire netting called a belly or chain belly. The lower edge of the frame has a raking bar, with or without teeth or swords depending upon the species of mollusc that is being caught. In use, the catch is lifted off the seabed or out of the sea by the raking (or teeth) bar and passes back into a basket or bag known as a belly. Depending on the size of the boat and the depth of water fished the number of dredges or ‘bags’ may vary from a single dredge towed behind the vessel to from 5 to 20 or more dredges per side. Dredges are generally attached to a towing bar and one is operated from each side of the vessel simultaneously.

Dredging for molluscs will now be described in more detail with reference to FIGS. 1 to 4. FIG. 1 shows a trawler 1 which has a tether or trawl warp 3 connected between the winch of the boat and a dredge 5 which is pulled along the sea bed 9. FIG. 2 shows the features of a typical dredge set up. The dredges 11 are connected to the trawler via the trawl warp 3 which connects to a towing triangle 13. Four chain bridles 15 extend from the towing triangle 13 and are connected to a tow bar which has a pair of bobbin wheels 17. The tow bar couples the chain bridles 15 to dredges 21.

The dredges 21 are shown in more detail in FIG. 3. In this figure dredge 23 comprises a frame 25 and a net bag 26. The frame is typically made from steel and has a plurality of teeth—the swords or toothbars 31 which extend downwards from the frame. Eyebolt 27, H-plate 29, spring 32 and paw 33 provide the mechanism by which the sword 31 engages and disengages with the sea bed in order to disturb the molluscs. In use, the molluscs are dug out from the sea bed by the sword 31, they gather along the front surface of the frame 34 and then they pass through the frame into the net 26.

In this example of the prior art, the net or belly 26 has a seabed engaging lower portion 37 and an upper portion 35. Typically, the seabed engaging lower portion 37 is dragged along the seabed, in use. As a consequence, the seabed engaging lower portion has to be made from a suitably robust material. An example of this type of seabed engaging portion is shown in FIG. 4 where the chain/net 39 which is designed to be dragged along the sea bed comprises steel rings 41 connected via washers 43. The size of mollusc that is retained in the belly depends upon the mesh size of the belly. As will be appreciated, the mesh of the belly is the array of holes formed in the belly either by the mesh sides of the netting in the upper portion or the mesh sides 44, 46 formed by the rings in the ground engaging portion.

There are a number of problems associated with the type of dredging apparatus described above. Dredging in general is viewed as having a significant environmental impact because it agitates the sea bed and in the process causes significant damage. Secondly, the act of dragging the dredges along the sea bed requires the trawler to use significant amounts of fuel to power its engines. Thirdly, the sea bed engaging portion of the belly is scraped along the sea bed and experiences considerable wear and tear; typically, these components last about two to six months before having to be replaced.

### SUMMARY OF THE INVENTION

In accordance with a first aspect of the invention there is provided a belly for a fishing dredge, the belly comprising a sea bed engaging portion and an upper portion, wherein the sea bed engaging portion comprises:

a plurality of rotatably mounted rollers and connectors which together form a mesh such that at least one of the rollers forms at least part of at least one the mesh sides of the mesh.

Advantageously, the belly of the present invention can roll across the sea bed thereby reducing the damage to the sea bed.

In addition, the amount of drag caused by the dredge is reduced thereby reducing the fuel required to pull the dredge across the sea bed.

A further advantage is that because the belly experiences less friction, it experiences less wear and tear and lasts longer.

Preferably, the rollers are cylindrical.

Preferably, the cylindrical rollers have a castellated profile.

Optionally, the rollers are substantially spherical.

Preferably, rollers are mounted on an axle.

Preferably, the axle extends out from the roller such that a plurality of rollers can be mounted on a single axle.

In this way, the axle functions as the point about which the roller rotates and as a connector which connects a plurality of rollers.

Preferably, the rollers are mounted in a row.

Preferably, connectors connect the rows together.

Preferably, the connectors which connect the rows together have coupling means which connect them to the axle.

Preferably, the coupling means is releasably connected to the axle.

Preferably, the connectors which connect the rows together have coupling means which connect them to the rollers.

Preferably, the roller is releasably connected to the axle.

Optionally, the rollers are connected together by flexible and rigid members.

Optionally, each roller has its own axle.

Preferably, the upper portion is a net.

Preferably, spacers are positioned between the rollers.

Preferably, the rollers are made of metal.

Preferably, the rollers are made of plastic.

Preferably, the rollers are made of rubber.

In accordance with a second aspect of the invention there is provided a roller for use in a fishing dredge belly as described with reference to the first aspect of the invention.

In accordance with a third aspect of the invention there is provided a kit of parts for making the seabed engaging portion of a belly for a fishing dredge as described in relation to the first aspect of the invention.

In accordance with a fourth aspect of the invention there is provided a belly for a fishing dredge, the belly comprising a base and an upper portion, wherein the base comprises:

a frame adapted to receive at least one rotatably mounted roller which extend from the frame towards the seabed in use, and a mesh that extends across the frame and which with the upper portion of the belly forms a collector.

Advantageously, the belly of the present invention can roll across the sea bed thereby reducing the damage to the sea bed.

In addition, the amount of drag caused by the dredge is reduced thereby reducing the fuel required to pull the dredge across the sea bed.

A further advantage is that because the belly experiences less friction, it experiences less wear and tear and lasts longer.

Preferably, the frame has a front portion adapted for connection with a fishing dredge.

Preferably, the rollers are mounted along the sides of the frame.

Preferably, the rollers are housed in a channel that extends substantially along the sides of the frame.

Optionally, at least one of the frame members comprises at least a portion of flexible material.

Optionally, the mesh is a rigid structure.

Optionally, the mesh is a flexible structure.

In some cases the flexibility designed into the frame and mesh may allow the rollers to remain in contact with an uneven seabed to a greater extent than a rigid frame and mesh by providing a greater degree of play or bend across the frame.

Preferably, the rollers are cylindrical.

Preferably, rollers are mounted on an axle.

Preferably, the upper portion is a net.

Preferably, the rollers are made of metal.

Preferably, the rollers are made of plastic.

Preferably, the rollers are made of rubber.

Preferably, the frame is rigid

Optionally, the frame is flexible.

Preferably, the frame comprises a plurality of roller accepting locations to which rollers may be removeably attached.

Advantageously, the number of rollers used can be selected depending upon the seabed conditions and the amount of seabed erosion that it is anticipated the rollers might cause. Where seabed conditions permit, a belly with more rollers can be used, this reduces wear and tear on the belly and increases its operational life.

### BRIEF DESCRIPTION OF THE DRAWINGS

The present invention will now be described with reference to the accompanying drawings in which:

FIG. 1 is illustrates the process of dredge fishing;

FIG. 2 illustrates a known type of fishing dredge;

FIG. 3 is a side view of a known type of fishing dredge frame and belly;

FIG. 4 is a side view of the sea bed engaging portion of the belly illustrated in FIG. 4;

FIG. 5 shows an example of the sea bed engaging portion of a belly in accordance with the present invention;

FIG. 6a is a perspective view of a roller in accordance with the present invention;

FIG. 6b is a side view of an axle in accordance with the present invention;

FIG. 6c is a side view of a connector in accordance with the present invention;

FIG. 7 is a side view of a fishing dredge frame attached to a belly in accordance with the present invention;

FIG. 8 is a further example of the sea bed engaging portion of a belly in accordance with the present invention.

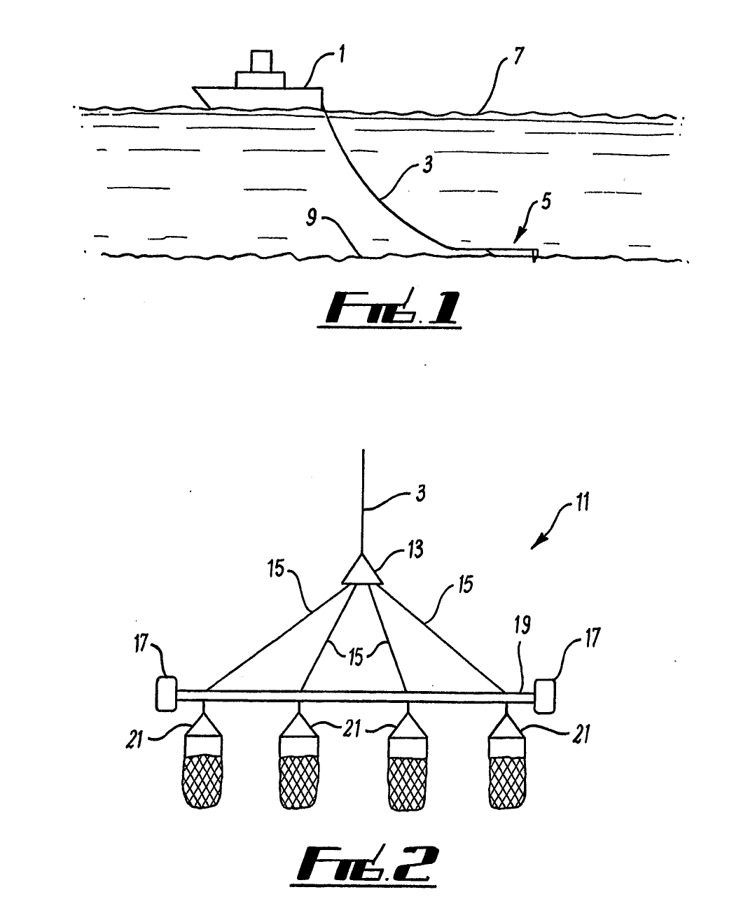

### DETAILED DESCRIPTION OF THE DRAWINGS

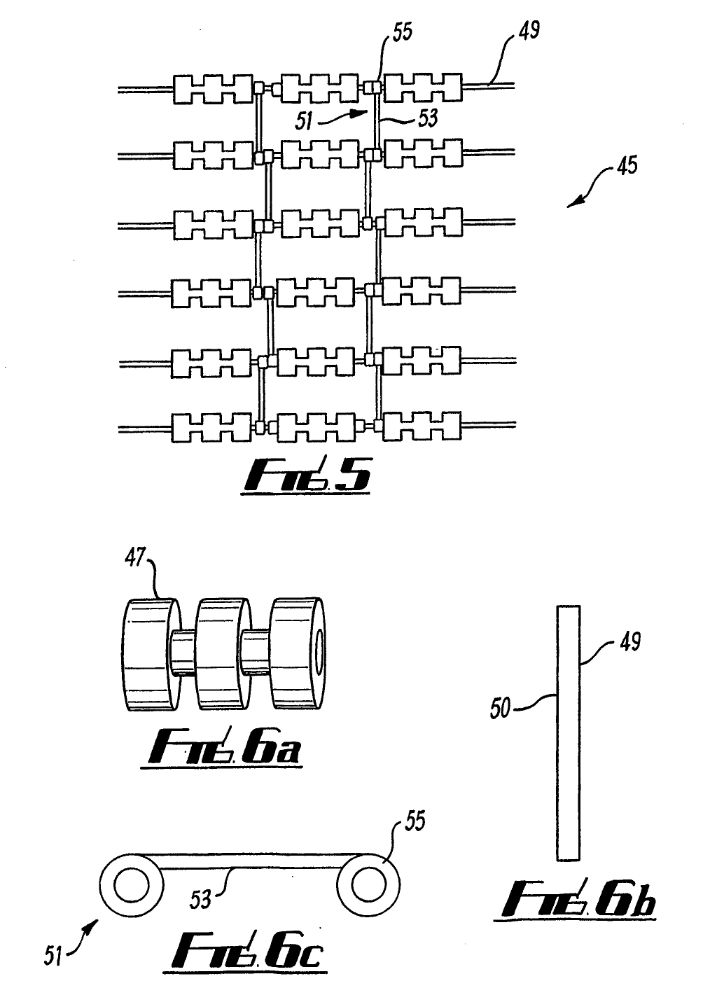

An embodiment of the belly in accordance with the present invention is described with reference to FIG. 5.

FIG. 5 shows arrangement of rollers which form the seabed engaging portion 45 of a belly. This comprises a plurality of rollers 47 connected together in a row by means of a mounting rod or axle 49. The rows are connected together via connectors 51 which comprise rotatably mounted couplers 55 which connect to the mounting rod or axle 49. The rotatably mounted couplers give a degree of flexibility within their seabed engaging portion of the belly which allows it to more easily moved over obstacles such as rocks. The arrangement of rollers, axles and connectors shown in FIG. 5 provide a suitable mesh which allows smaller objects to pass out from the belly whilst retaining the mollusc in the belly.

The couplers 55 also act as spacers to prevent the rollers from the contact with one another. The ability of each roller to move independently from the others provides an advantage because not all of the rollers in a row may be in contact with the seabed at the same time, therefore turning each roller requires less energy.

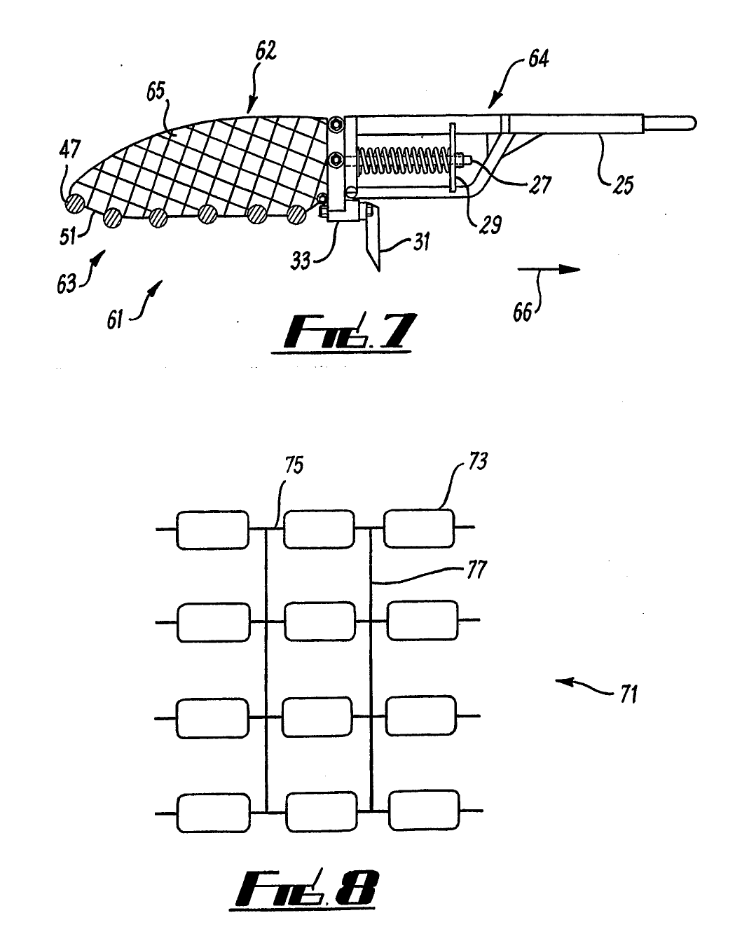

FIG. 6a shows one example of a roller in accordance with the present invention. The roller 47 comprises three connected cylinders which have a castellated profile. One advantage of this design is that the overall weight of the rollers is reduced in comparison to a roller made from a solid cylinder.

FIG. 6b shows one example of an axle about which the roller can rotate. The shaft of the axle 50 extends through a plurality of rollers to allow a number of rollers to be mounted on a single shaft. Each roller is free to rotate about the shaft.

FIG. 6b shows one embodiment of a connector. The connector has a connecting rod 53 with rings 55 at either end of the connecting rod 53. The rings 55 are sized to fit around the axle 49 and to be rotatable about that axle. In doing so, the ground engaging portion of the belly has a degree of flexibility on its length which allows it to more easily move across the seabed.

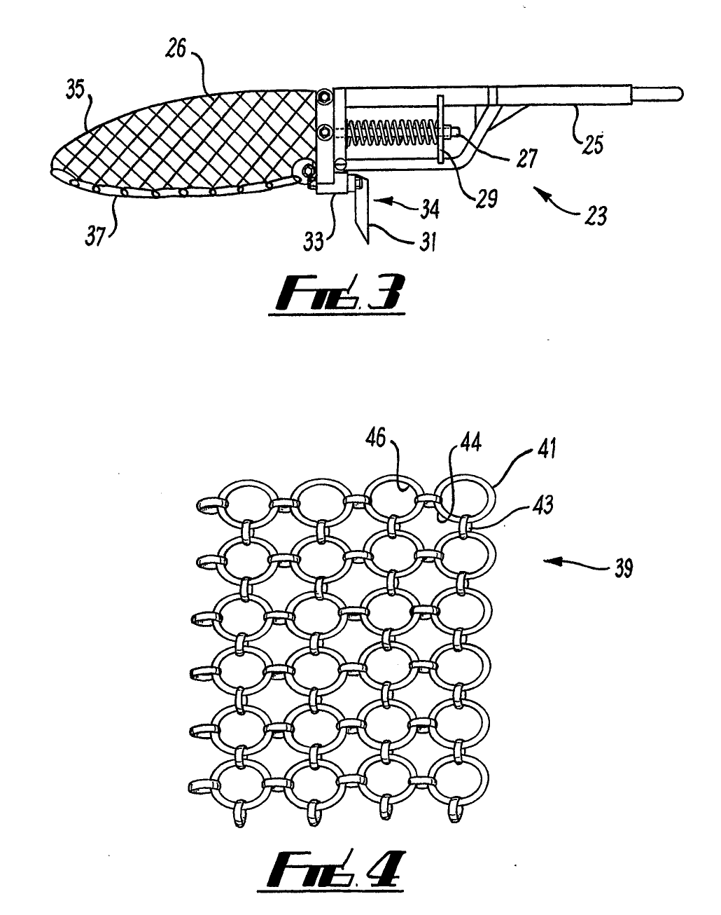

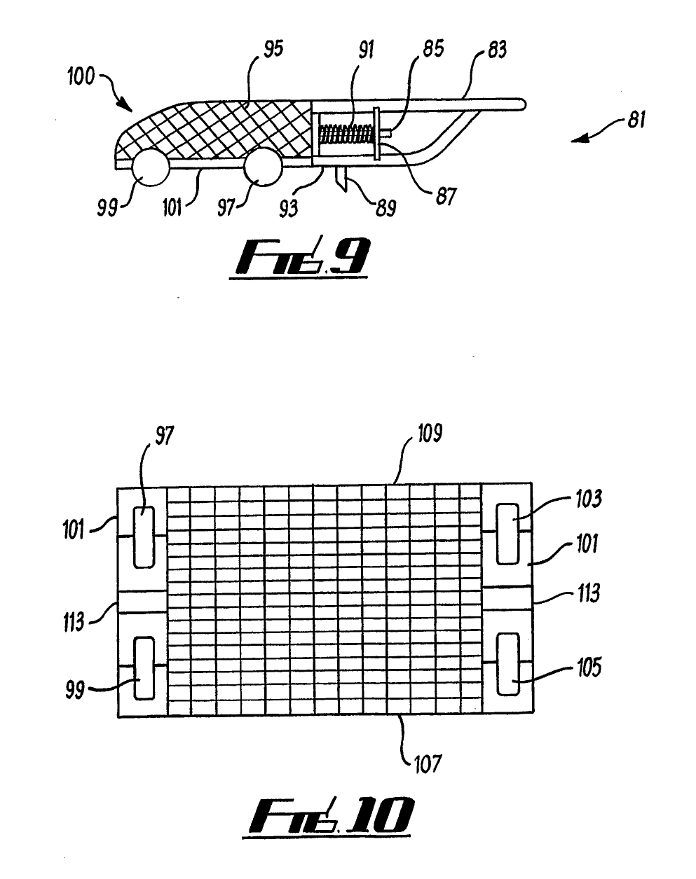

FIG. 7 shows an example of a belly 62 in accordance with the present invention connected to a dredge frame 64. The dredge frame is as described with reference to FIG. 3. The belly 62 comprises a net 65 which can be constructed of any suitable net material and which has a predetermined mesh size suitable for catching a mollusc of a certain size. The seabed engaging portion 63 of the belly 62 comprises a series of rollers 47 connected together by means of the connectors 51. In this example of the present invention, the rollers extend across the width of the frame (not shown).

In use, the dredge frame 64 is connected to the belly 62 by any suitable connector and sunk to the seabed in order to commence dredging. During the dredging process, the frame is pulled in the direction shown by arrow 66 such that the sword 31 cuts through their seabed and uncovers a number of molluscs. The molluscs and then collected in the belly as described above.

Advantageously, the seabed engaging portion of the belly in accordance with the present invention is able to roll across the seabed instead of being dragged across the seabed as is the case with known types of belly. This decreases the wear and tear experienced by the belly and reduces the power required to tow the belly and dredge frame across the seabed.

FIG. 8 shows a second embodiment of the present invention in which the seabed engaging portion of the belly comprises a series of solid roller 73 connected together by wire connectors 75 and 77. The wire connectors 75 and 77 provide a degree of flexibility within the seabed engaging portion of the belly. It should be noted that this example of the present invention the rollers 73 each have axles which are independent of one another and which are connected to the wire 75 at or near the outer edge of each roller.

In a preferred embodiment of the invention where the belly is attached to a dredge for use in catching king scallops, a mesh size of 70 mm×50 mm provided a good catch of scallops.

One problem with existing scallop bellies is that during a dredging run, the bellies fill up with scallops (including undersized scallops), stones and other material. This means that when the dredges are lifted from the sea bed, a significant proportion of the contents of the belly is made up of undersized scallops, stones and other material which is heavy and must be returned to the water.

A further advantage of the invention is that the scallop belly can “filter” stones, undersized scallops and other material out from the belly as it moves across the sea bed. Therefore, the amount of stones and other material that is retained in the dredge when it is lifted from the sea bed can be significantly reduced. Clearly, this will mean that more scallops can be caught in a single dredging run which will make the process of catching scallops more efficient because, less dredging and therefore, less fuel is required to catch the same number of scallops. Fewer dredging runs can also reduce the amount of damage to the sea bed.

In addition, emptying the prior art bellies on the deck of a boat is labour intensive and time consuming because the scallops, undersized scallops, stones and other material would often get stuck in the rings and washers. It has been found that the rollers make it much easier and quicker to empty the belly because, when the belly is tipped upside down on the deck of the vessel, the rollers turn and the contents simply falls out of the belly.

The rollers of the belly can suitably be made form metal such as steel, plastic, rubber or a combination of these materials. The choice of material depends upon the durability and weight requirement of the belly. Embodiments of the present invention have been made using plastic rollers and rubber rollers with the rubber material having greater durability. In addition, the rollers cam be stamped or otherwise marked with an identifier which allows the user to verify the authenticity of the rollers being supplied and used. Marking can include adding a luminous dye to the rubber or plastic, stamping the roller and/or providing a barcode on the roller.

The axles and connectors which couple the rollers together forming the mesh are typically made from steel or another hard wearing robust material.

It will be appreciated that other examples and embodiment of the present invention could use different types of roller including rollers which are substantially spherical in shape, very slim rollers which have the appearance of wheels mounted to the seabed engaging portion of the belly. In addition the seabed engaging portion of the belly may comprise a combination of rollers and the well-known ring and washer arrangement described in FIG. 4.

The third embodiment of the present invention is shown in FIGS. 9 and 10. This embodiment differs from the previous embodiments in that it is provided with rollers in the form of wheels which are arranged along the sides of a frame which may be flexible, rigid or semi-rigid and which is held above the seabed by the rollers.

The frame comprises the lower portion of the scallop belly into which scallops are collected during the dredging process. This embodiment of the present invention is particularly useful for collection Queen Scallops. The third embodiment as shown in FIGS. 9 and 10 comprises a dredge 81 which has a dredge frame 83 similar to that shown in previous embodiments of the present invention. The dredge frame 83 comprises an eye bolt 83, an H-plate 87, a sword or tooth, spring 91 and a paw 93.

It should be noted that the tooth 89 is significantly shorter in this embodiment of the present invention. As mentioned above, this embodiment of the present invention is preferred for the collection of Queen Scallops which are found just below the seabed surface and accordingly the tooth which is used to dig up the surface of the seabed is much shorter than that which is required for catching King Scallops.

The scallop belly 100 is described herein with reference to FIGS. 9 and 10. It comprises front wheels 97, 103, rear wheels 99, 105, a frame with two side members 101, a front member 109, and a rear member 107, a mesh 111, and supports 113. As can be seen, the belly is connected to the scallop dredging frame 83 and is designed to be pulled along the seabed on the wheels 97, 103, 99 and 105. As can be seen from the plan view of FIG. 10 the wheels are mounted on axles which are contained within side portions of the frame. This separates out the wheels from the remainder of the mesh section. Accordingly the wheels are isolated from the rest of the belly and therefore do not come into contact with the contents of the belly in use.

It has been found that this embodiment of the present invention in common with the previous embodiments allows the belly to be moved across the seabed without incurring additional damage to the seabed by minimising the amount of abrasion between the belly and the seabed. In addition, this can reduce the amount of fuel used by the trawler and better preserves the sea bed.

In another embodiment of the present invention similar to that shown in FIGS. 9 and 10, the frame of the belly can be designed to incorporate a variable number of rollers. The number of rollers used can be selected in depending upon the seabed conditions and the amount of seabed erosion that it is anticipated the rollers might cause. Where seabed conditions permit, a belly with more rollers can be used, this reduces wear and tear on the belly and increases its operational life.

The first and second embodiments of the apparatus of the present invention are particularly useful when used to catch King scallops but may for example be used when fishing for other bivalvate molluscs such as Queen scallops. The third embodiment of the apparatus of the present invention is particularly useful when used to catch Queen scallops. The use of the apparatus in accordance with the present invention for other types of dredge fishing is not excluded.

Improvements and modifications may be incorporated herein without deviating from the scope of the invention.

1. A belly for a fishing dredge, the belly comprising a sea bed engaging portion and an upper portion, wherein the sea bed engaging portion comprises:
a plurality of rotatably mounted rollers and connectors which together form a mesh such that at least one of the rollers forms at least part of at least one the mesh sides of the mesh.

2. A belly as claimed in claim 1 wherein, the rollers are cylindrical.

3. A belly as claimed in claim 2 wherein, the cylindrical rollers have a castellated profile.

4. A belly as claimed in claim 1 wherein, the rollers are substantially spherical.

5. A belly as claimed in claim 1 wherein, rollers are mounted on an axle.

6. A belly as claimed in claim 5 wherein, the axle extends out from the roller such that a plurality of rollers can be mounted on a single axle.

7. A belly as claimed in claim 6 wherein, the axle functions as the point about which the roller rotates and as a connector which connects a plurality of rollers.

8. A belly as claimed in claim 1 wherein, the rollers are mounted in a row.

9. A belly as claimed in claim 8 wherein, connectors connect the rows together.

10. A belly as claimed in claim 8 wherein, the connectors which connect the rows together have coupling means which connect them to the axle.

11. A belly as claimed in claim 1 wherein, the coupling means is releasably connected to the axle.

12. A belly as claimed in claim 8 wherein, the connectors which connect the rows together have coupling means which connect them to the rollers.

13. A belly as claimed in claim 5 wherein, the roller is releasably connected to the axle.

14. A belly as claimed in claim 1 wherein, the rollers are connected together by flexible and rigid members.

15. A belly as claimed in claim 5 wherein, each roller has its own axle.

16. A belly as claimed in claim 1 wherein, the upper portion is a net.

17. A belly as claimed in claim 1 wherein, spacers are positioned between the rollers.

18. A belly as claimed in claim 1 wherein the rollers are made of metal.

19. A belly as claimed in claim 1 wherein the rollers are made of plastic.

20. A belly as claimed in claim 1 wherein the rollers are made of rubber.

21. A belly as claimed in claim 1 wherein, the roller further comprises an identifier for verifying the authenticity of the roller.

22. A roller for use in a belly as claimed in claim 1.

23. A kit of parts for making the seabed engaging portion of the belly for the fishing dredge of claim 1.

24.-38. (canceled)
